(19) United States
(12) Patent Application Publication
(10) Pub. No.: US 2002/0127283 A1
(43) Pub. Date: Sep. 12, 2002

(54) Novel processed legumes and processes for preparing the same

(76) Inventors: Mark H. Sterner, Riverside, CA (US); Mark M. Sterner, Roseburg, OR (US)

Correspondence Address: Edward O. Kreusser, Brobeck, Phleger & Harrison LLP, 12390 El Camino Real, San Diego, CA, 92130-2081, US

(21) Appl. No.: 09/798,098

(22) Filed: Mar. 2, 2001

(51) Int. Cl. A23L 1/20

(52) U.S. Cl. 424/630

(57) ABSTRACT

Novel methods of processing legumes to reduce unwanted oligosaccharides and trypsin inhibitors are described. The process is economical, fast, and results in products that have improved nutritional value and that are amenable to many different types of subsequent processing and uses.

### FIELD OF THE INVENTION

The field of the invention relates to legume-processing.

### BACKGROUND OF THE INVENTION

The following description includes information that may be useful in understanding the present invention. It is not an admission that any of the information provided herein is prior art, or relevant, to the presently claimed inventions, or that any publication specifically or implicitly referenced is prior art.

Legumes, beans in particular, are highly nutritious staple and snack foods, but possess several properties that hamper their popularity and/or utility as foodstuffs. See, e.g., Revilleza et al. (1990), Plant Food for Human Nutrition 40:83-93. First, legumes have been shown to contain oligosaccharides of the raffinose family, including, e.g., raffinose, stachyose and verbacose in which galactose is present in a.-linkage. These types of oligosaccharides have been shown to be responsible for rectal gas expulsions, abdominal rumbling, cramps, diarrhea, and nausea following consumption. This results in discomfort not only to the consumer, but also an annoyance to those around the consumer. Second, legumes are known to possess trypsin inhibitors, which thwart digestion and absorption of proteins upon ingestion. Third, legume flavor can be strong and distasteful to some.

Attempts at minimizing or negating these undesirable features have so far met with only limited success. Techniques employed to date include, e.g, enzymatic digestion of the oligosaccharides by addition of enzyme prior to consumption, boiling and leaching attempts directed at extracting the oligosaccharides, and roasting to inactivate the oligosaccharides. See, e.g., U.S. Pat. Nos. 3,632,346, 3,958,015, 5,989,544, 5,902,617, 5,773,427, 5,651,967, 5,445,957, and 5,436,003.

These techniques as a whole are expensive, complex, time-consuming, and generally unsatisfactory relative to the instant invention and the products produced thereby.

### SUMMARY OF THE INVENTION

Applicant has unexpectedly discovered a convenient process of processing legumes that results in a nutritious, palatable, more economic legume product, with substantially less potential for flatulence upon consumption. While the invention is demonstrated herein using soybeans, Applicant anticipates that the process is applicable to other beans and legumes as well. The method includes heating followed by rapid cooling. The resulting product is at once reduced in active trypsin inhibitors, and also reduced in oligosaccharides that contribute to flatulence. Additional advantages include a more bland (less strong) taste and an otherwise substantially preserved or enhanced nutritional value.

Accordingly, in a first aspect the invention features a method of processing a legume for consumption. The method includes applying to a legume a heat sufficient to at least partially inactivate oligosaccharides (preferably that carry galactoses with a-linkages) and trypsin inhibitors within the legume while not toasting the legume. The heat is preferably administered rapidly and for a short duration.

In some embodiments, the legume has a starting moisture content of between about 8 and 18% and the heat administered is about 250° F. for between about 2 and 3 minutes, followed by cooling with a stream of air. Preferably, although not necessarily, cooling is to about 100° F. or less within about 1 minute or less of the time from the end of heating. Heating is preferably, although not necessarily, performed using a microwave, hot air, or infrared oven, although persons of skill will appreciate that other heating techniques may also suffice. In some embodiments, a hot oil or fine particulate matter such as sand or salt may be used. In some embodiments, the legume is dry-cleaned prior to heating. The legume may also be sized prior to heating. In preferred embodiments, the legume is a bean, preferably a soybean.

Cooling should be rapid to quickly stop the cooking process. This can be done using a variety of techniques, including passing cold air or oil across the heated beans, or else using cold CO₂ “snow” or a cold granular medium such as salt or sand that can readily be separated away from the processed product.

Following cooling, an optional de-hulling step may be employed that cracks the hull, e.g., using cracking rollers or scarafiers as known in the art, to the extent that the hulls can then be conveniently separated away using a an aspirating or other technique.

In a second aspect, the invention features a product produced by any method embodiment or combination of method embodiments of the first aspect.

Advantages of the invention include economically reducing trypsin inhibitor units (TIU), inactivating urease, improving the protein efficiency ratio (PER), improving nitrogen solubility index (NSI), altering oligosaccharides, and altering taste. These are all a consequence of the controlled cooking/cooling process described herein. The terms of art, TIU, PER, and NSI, are all well-known in the art. Other advantages, aspects, and embodiments of the invention will be apparent from the figures, the detailed description, and the claims.

### BRIEF DESCRIPTION OF THE DRAWINGS

FIG. 1 is an illustrative embodiment of a process of the invention, various steps of which, e.g., the sizing separating, dehulling, grinding, and packaging steps, are optional.

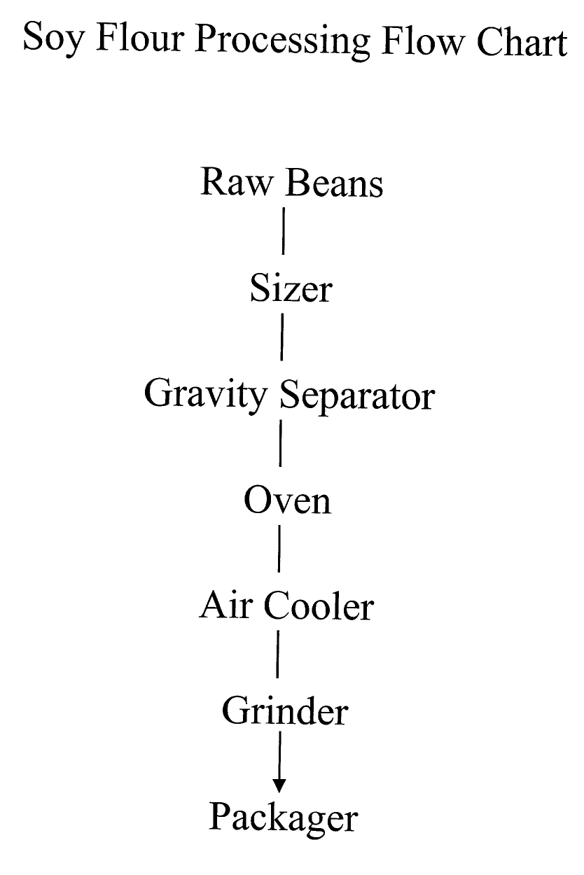

### DETAILED DESCRIPTION OF THE INVENTION

The invention has advantages in production costs and results in a desirable product for consumers. While the products and processes described herein find particular merit in consumable products for humans and mammalian livestock, the invention is by no means so limited in intended scope.

The invention derives from Applicant's observation that a rapid and brief heating, followed by a rapid cooling can selectively negate or limit undesirable traits of legumes while preserving and/or manufacturing new desirable traits. Specifically, the limited, controlled heating eliminates or lessens oligosaccharides that contribute to flatulence, and fuirther reduces the activity of trypsin inhibitors. Usually, taste is also modified in the process, and favorably so.

### EXAMPLE 1

Soy Bean Processing

Raw soy beans of the Vintor variety (10% moisture content) are dry-cleaned, e.g., using an air separator to remove light particulate matter, then sized using a sizing screen separator (16/64 \mathring{×}¾ inch screen over 14/64 \mathring{×}¾ inch screen) as understood and used in the art. A gravity separator as known in as known in the art is then used to remove, e.g., rocks and stones. The beans are then placed in a microwave oven and cooked for approximately two minutes, which endows a cooking temperature of about 250° F. (as measured using an infrared sensor). The beans are then immediately air cooled to less than 100° F., preferably room temperature. The quick cooling halts the beans from continuing to cook, which would have the deleterious effect of changing the desired nutrient value and texture of the finished product. One of skill knows that beans of a larger diameter would require more cook time and/or heat intensity to a achieve a similar effect, and that beans of a smaller diameter would require less cook time and/or heat intensity to a achieve a similar effect. However, one of ordinary skill in the art can, without undue experimentation, determine these modifications.

The resulting product is then optionally ground into a flour or gritty consistency (see, e.g., U.S. Pat. Nos. 4,859,482 and 3,941,890) and packaged using any one of a variety of well-known techniques in the art. It is anticipated that the grinding and cooling steps can be condensed into a single step in which the cooked product is cooled and ground simultaneously. A de-hulling step may also be incorporated, preferably following cooling.

### EXAMPLE 2

Measuring Polysaccharides and Trypsin Inhibitor Activity

Oligosaccharides can be measured using standard extraction techniques, e.g., using ethanol, followed by chromatography. An example is found in Revilleza et al. (1990), Plant Food for Human Nutrition 40:83-93: Samples (e.g., 500 mg) were extracted three times with 5 ml of hot 70% ethanol with shaking for 30 min at 60° C. The supernatants were pooled and concentrated in vacuo at 45° C. to 1.0 mL. Four drops of saturated lead acetate solution were added to precipitate non-carbohydrate material. After removal of precipitate by centrifugation, the excess lead was removed by adding one drop of staurated monopotassium phosphate. An aliquot containing 1-5 ug of sugars was spotted on an HPTLC plate (Merck Silica Gel 60) with a 10 ul microsyringe and developed for 4 h in a fresh solvent system of pyridine:n-butanol H₃O [s:14:4 (v/v/v). Triple development enhanced separation and eliminated most of the tailing, which was carried out by drying the plates under the hood for 30 min prior to redevelopment in the same direction.

The sugars were visualized by using a modified procedure of Jeffrey et al. (1969) J Chromatog. 41:475-80, consisting of spraying with a mixture of 100 mg dephenylamine, 0.1 mL aniline, 0.4 mL of 80% orthophosphoric acid in 4 mL acetone and 15 mg benzidine in 32.0 mL glacial acetic acid. The plates were incubated in a convection oven at 100° C. for 10 min.

Reference standards containing 10 mg/mL each of glucose, sucrose, raffinose and stachyose may be used as standards (Nakarai Chemical Ltd) Response factor for each sugar standard may be calculated and plotted against the degree of polymerization or the number of moonsaccharide units. Response factor for verbacose was extrapolated from the graph as in Sosulski et al. (1982) J. Food Sci. 47:498-502.

Individual sugars may be quantified by comparing their response factors with that of the corresponding sugar standard. Results may be expressed as g sugar/100 g dry wt. of the sample.

Another example of oligosaccharide determnination, as well as methods of determining nutritional value, may be found in U.S. Pat. No. 6,146,669.

Trypsin inhibitor activity can be measured using, e.g., enzymatic assays. Examples are found in U.S. Pat. Nos. 5,714,580 and 6,011,158. Enzyme activity can be determined using as substrate S-2222, purchased from Kabi Diagnostica or Pharmacia-Upjohn. The substrate is made up in deionized water prior to use. The assay is run by combining in appropriate wells 50 uL TBS and 50 .uL inhibitor sample in TBS or TBS alone and 50 .uL of 40 nM bovine trypsin (or TBS as background control), incubating this mixture for 30 minutes at room temperature, adding 50 uL 1.8 mM S-2222, incubating for an additional 30 minutes at room temperature, then reading the absorbance of the wells at 405 nm on a microtiter plate reader set with background substraction at 650 nm. Purified (3X-crystallized; TRL3) bovine pancreatic trypsin for use as a control may be obtained from Worthington Biochemical Corp.

Trypsin inhibitor activity can also be measured indirectly by monitoring the activity of the enzyme, urease. Both proteins are found in legumes and display similar heat inactivation profiles. Urease is easy to measure because it catalyzes the hydrolysis of urea to ammonia, which can be conveniently measured by pH change. See, e.g., U.S. Pat. No. 4,147,810.

The foregoing embodiments are illustrative only and not intended to be limiting of the claimed inventions.

All patents and publications mentioned above are within the levels of ordinary skill in the art to which the invention pertains. All ingredients and hardware used in the processes are either known and available commercially, or else readily acquired and/or produced without undue experimentation according to standard methodologies and sources within the art. All references cited in this disclosure are incorporated by reference to the same extent as if each reference had been incorporated by reference in its entirety individually. None of the references are admitted to be prior art.

One skilled in the art would readily appreciate that the present invention is well adapted to carry out the objects and obtain the ends and advantages mentioned, as well as those inherent therein. The methods and compositions described herein as presently representative of preferred embodiments are exemplary and are not intended as limitations on the scope of the invention. Changes therein and other uses will occur to those skilled in the art, are encompassed within the spirit of the invention, and are defined by the scope of the claims.

It will be readily apparent to one skilled in the art that varying substitutions and modifications may be made to the invention disclosed herein without departing from the scope and spirit of the invention. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, optional features, modification and variation of the concepts herein disclosed may be resorted to by those skilled in the art, and that such modifications and variations are considered to be within the scope of this invention as defined by the description and the appended claims.

In addition, where features or aspects of the invention are described in terms of Markush groups or other grouping of alternatives, those skilled in the art will recognize that the invention is also thereby described in terms of any individual member or subgroup of members of the Markush group or other group, and exclusions of individual members as appropriate.

I claim:

1. A method of processing a legume for consumption, comprising applying to a legume heat sufficient to at least partially inactivate oligosaccharides and trypsin inhibitors within said legume while not toasting said legume.

2. The method of claim 1 wherein said legume has a starting moisture content of between about 8 and 18%.

3. The method of claim 1 wherein said heat is about 250° F. administered for about 2 to 3 minutes, followed by rapid cooling.

4. The method of claim 1 wherein said heat is generated by a microwave oven.

5. The method of claim 1 wherein said heat is administered by a stream of hot air.

6. The method of claim 3 wherein said cooling is to about 100° F. or less within about 1 minute of time from the end of heating.

7. The method of claim 1 wherein said legume prior to applying said heat is dry-cleaned.

8. The method of claim 1 wherein said legume prior to applying said heat is sized.

9. The method of claim 1 wherein said legume is ground into a grit or flour following said at least partial inactivation of said trypsin inhibitors and oligosaccharides.

10. The method of claim 1 wherein said oligosaccharides contain galactose that is present in α-linkages.

11. The method of claim 1 wherein said legume is a bean.

12. The method of claim 11 wherein said legume is a soybean.

13. The method of claim 3 wherein said rapid cooling is accomplished with the use of cool air.

14. The method of claim 3 wherein said rapid cooling accomplished using CO₂ snow.

15. The method of claim 3 wherein said rapid cooling accomplished by commingling with a cool, separable granular substance.

16. A product produced according to the method of any of claims 1-12.

17. The product of claim 16 wherein said product is used as an animal feed.
